(19) United States
(12) Patent Application Publication
(10) Pub. No.: US 2008/0085428 A1
(43) Pub. Date: Apr. 10, 2008

(54) Silicon Substrate For Magnetic Recording Meduim, Method Of Manufacturing The Silicon Susbstrate And Magnetic Recording Medium

(75) Inventor: Katsuaki Aida, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/660,055

(22) PCT Filed: Aug. 11, 2005
(86) PCT No.: PCT/JP05/15041

§ 371 Date: Feb. 12, 2007

Related U.S. Application Data
(60) Provisional application No. 60/603,565, filed on Aug. 24, 2004.

(30) Foreign Application Priority Data
Aug. 16, 2004 (JP) 2004-236580

(51) Int. Cl. G11B 5/73; G11B 5/84

(52) U.S. Cl. 428/836.3; 427/130; 428/848

(57) ABSTRACT

In a silicon substrate for a magnetic recording medium, a curved surface having a radius from 0.01 mm to 0.05 mm is provided at an edge portion between a main surface and an end face of the substrate. The curved surface may be provided at an outer periphery or an inner periphery of the substrate. Preferably, the maximum heights for surface roughness for the end face and the main surface are respectively 1 μm or less and 10 nm or less. A manufacturing method for a silicon substrate includes forming a circular hole at a center of the silicon substrate; immersing the substrate in a polishing liquid in which grains are suspended; and respectively polishing outer and inner peripheral end faces of the substrate. In polishing of each end face, a polishing brush contacts the end face while performing a relative rotation between the end face and the polishing brush.

Priority is claimed on Japanese Patent Application No. 2004-236580, filed Aug. 16, 2004, and U.S. Provisional Patent Application No. 60/603,565, filed Aug. 24, 2004, the contents of which are incorporated herein by reference.

### TECHNICAL FIELD

The present invention relates to a silicon substrate for a small-sized magnetic recording medium, which is used as a recording medium for a data processing apparatus.

### BACKGROUND ART

Accompanying recent progress in data processing apparatuses, data recording capacity of a magnetic recording medium has increased more and more. In particular, in magnetic disks, which are important media as external memory for computers, both storage capacity and data recording density increase every year, and development for recording data with higher density is required. For example, in accordance with development of notebook computers or palmtop computers, small-sized and impact-resistant magnetic recording media are required, and therefore small-sized magnetic recording media for recording data with higher density, which also have high mechanical strength, are required. More recently, navigation systems or portable music reproducing systems may employ ultra-small-sized magnetic recording media.

A substrate made of aluminum alloy, which may be plated with NiP, or a glass substrate, is conventionally used as a substrate for a magnetic disk which is a magnetic recording medium as described above. A substrate made of aluminum alloy has inferior abrasion resistance and processability, and plating with NiP is performed so as to solve this problem. However, a substrate which has been subjected to NiP plating tends to be warped, and may be magnetized when being processed at a high temperature. In addition, when the glass substrate is processed so as to be strengthened, a distortion layer may be produced in a surface of the substrate and the substrate may receive compressive stress, and the glass substrate also tends to be warped when being processed at a high temperature.

Regarding an ultra-small-sized magnetic recording medium having a diameter of 1 inch (i.e., 25.4 mm) or 0.85 inches (i.e., 21.6 mm) which requires higher recording density, warp of the substrate is a fatal problem. Therefore, as a substrate for an ultra-small-sized recording medium, a thinner material, which is not easily deformed by external force and has a smooth surface on which a magnetic recording layer can be easily formed, is required.

Accordingly, it has been proposed that a silicon substrate, which is popular as a substrate for semiconductor devices, be used as a magnetic recording medium (see, for example, Reference 1: Japanese Unexamined Patent Application, First Publication No. H06-076282).

In comparison with aluminum, single crystal silicon has a larger specific gravity, a larger Young's modulus, a smaller coefficient of thermal expansion, a superior high-temperature characteristic, and electrical conductivity. Such single crystal silicon having many advantages is preferable as a material for a substrate for a magnetic recording medium. In addition, the smaller the diameter of the substrate, the smaller impact force the substrate receives, and a magnetic recording device having durability can be produced even from a silicon substrate.

In order to manufacture the silicon substrate for a magnetic recording medium, generally, a single crystal silicon ingot is first produced by a pulling method, and the ingot is sliced into blank materials having a specific thickness.

Each blank material is subjected to a lapping process, and a circular through hole is formed at the center of the blank material. The inner and outer peripheral edges are subjected to chamfering using a grindstone or the like. The inner and outer end faces and the chamfered portions are then subjected to polishing, so as to produce mirror-finished surfaces. Finally, the main surface is polished, and the substrate is used.

The material for the silicon substrate is fragile; thus, cracks or chips tend to be produced in the above manufacturing processes. When cracks or chips are produced, the yield rate for manufacturing the magnetic recording medium is reduced, and generated particles may cause errors in a write/read process, or a crash of the magnetic head in the write/read process.

In order to obtain a substrate for the magnetic recording medium, which has no cracks or chips, from a fragile material, a method has been proposed in which for the inner periphery of the circular center hole and for the outer periphery of the substrate, the chamfering angle is set to be from 20° to 24°, and the chamfering length is set to be from 0.03 mm to 0.15 mm (see, for example, Reference 2: Japanese Unexamined Patent Application, First Publication No. H07-249223).

FIG. 10 is a longitudinal sectional view of a conventional silicon substrate for a magnetic recording medium. In FIG. 10, between an end face 4 and each of main surfaces 2 and 3 of the substrate 1, a chamfered portion 5 is formed, which is inclined at an angle from 20° to 24°. Similar chamfered portions (not shown) are also formed in the inner periphery of the substrate.

According to the above form for the substrate, defects in the substrate, such as cracks or chips due to handling or dropping the substrate in the manufacturing process, are reduced, and the yield rate is remarkably improved.

In addition, regarding the glass substrate, lower floating of the magnetic head has been planned so as to implement high density data recording, and the write/read method has been gradually switched from the CSS (contact start stop) method to the load and run method (or the ramp load method). These write/read methods also require a substrate which can be reliably installed and does not cause write/read errors, or a crash of the magnetic head in the write/read process.

In order to satisfy the above requirements, a substrate has been proposed in which curved surfaces having a radius from 0.003 mm to under 0.2 mm are provided at least one of (i) between the inner and outer end faces of the substrate and the chamfered portions, and (ii) between the main surfaces of the substrate and the chamfered portions (see, for example, Reference 3: Japanese Unexamined Patent Application, First Publication No. 2002-100031).

According to such a substrate, no cracks or chips are produced even when a substrate contained in a processing cassette (which is a case for storing and transferring a substrate in a manufacturing process) is transferred, and no write/read errors or crash of the magnetic head in the write/read process occurs, thereby providing a magnetic recording medium which can be reliably installed.

However, the silicon substrate is fragile, and in a processing cassette used in the manufacturing process, an end face of the substrate having a form disclosed in Reference 2 or 3 is disposed on a substrate acceptance place of the cassette. Therefore, the substrate causes a crack in the end face of the substrate or a chip on the substrate due to an impact in transfer, or rubbing against the processing cassette produces dust particles which may be included in the substrate and result in a substandard magnetic recording medium.

In addition, in a conventional method of manufacturing the silicon substrate, after each substrate is individually subjected to chamfering and grinding by using a grindstone, a stack of substrates is prepared and corner portions of inner and outer end faces are processed so as to create curved surfaces.

However, in this method, the chamfering and grinding process is performed for every substrate; thus, considerable time and labor are required, thereby increasing the cost.

Furthermore, when a chamfered portion is formed in an end face of the substrate, the recordable area on the main surface is reduced, which is not preferable for securing a required recording capacity for an ultra-small-sized magnetic recording medium.

### DISCLOSURE OF INVENTION

In view of the above circumstances, an object of the present invention is to provide a silicon substrate which is fragile but has a form by which cracks in an end face or chips on the substrate are not easily produced, thereby preventing the occurrence of dust particles produced from the end face of the substrate or due to rubbing against a processing cassette.

Another object of the present invention is to simplify the manufacturing process and improve cost reduction, thereby providing a low-priced ultra-small-sized magnetic recording medium.

Another object of the present invention is to secure a data recording area as wide as possible in the magnetic recording medium, thereby providing a magnetic recording medium having a large recording capacity.

Therefore, the present invention provides a silicon substrate for a magnetic recording medium, wherein a curved surface having a radius from 0.01 mm to 0.05 mm is provided at an edge portion between a main surface and an end face of the substrate.

In a typical example, the curved surface between the main surface and the end face is provided at an outer periphery or an inner periphery of the substrate.

Preferably, the maximum height for surface roughness for the end face is 1 μm or less, and the maximum height for surface roughness for the main surface is 10 nm or less.

The present invention also provides a manufacturing method for a silicon substrate for a magnetic recording medium, comprising the steps of:

forming a circular hole at a center of the silicon substrate;

immersing the silicon substrate in a polishing liquid in which grains are suspended; and

respectively polishing an outer peripheral end face and an inner peripheral end face of the silicon substrate, wherein in polishing of each end face, a polishing brush contacts the end face while performing a relative rotation between the end face and the polishing brush.

The step of respectively polishing the outer peripheral end face and the inner peripheral end face may be performed before inner and outer peripheries of the silicon substrate are subjected to chamfering.

Preferably, the step of respectively polishing the outer peripheral end face and the inner peripheral end face is performed in a batch processing using a stack body of a number of silicon substrates stacked via spacers therebetween.

In a typical example, the polishing brush is made of polyamide resin.

The present invention also provides a magnetic recording medium made using a silicon substrate as described above, wherein at least a magnetic layer is formed on the main surface of the silicon substrate.

According to the present invention, it is possible to obtain a silicon substrate which is fragile but has a form by which cracks in an end face or chips on the substrate are not easily produced, thereby preventing the occurrence of dust particles produced from the end face of the substrate or due to rubbing against a processing cassette. Therefore, a smaller number of substandard products and a smaller number of write/read errors are produced. In addition, it is possible to provide a low-priced ultra-small-sized magnetic recording medium having a large storage capacity.

### BRIEF DESCRIPTION OF THE DRAWINGS

FIG. 1 is a perspective view of a silicon substrate for a magnetic recording medium according to the present invention, which is cut and viewed from the cut face.

FIG. 2 is a diagram for explaining the dimension of each portion of the silicon substrate in FIG. 1 according to the present invention.

FIG. 3 is an enlarged view of an outer peripheral of the silicon substrate in FIG. 1 according to the present invention.

FIG. 4 is a diagram for explaining the method of measuring the radius R of the curved surface.

FIG. 5 is a diagram for explaining the processes for manufacturing the silicon substrate according to the present invention.

FIG. 6 is a diagram for explaining the processes for manufacturing a conventional silicon substrate.

FIG. 7 is a diagram showing a portion of a stack body of silicon substrates used according to the present invention.

FIG. 8 is a diagram for explaining the method of brush-polishing the inner peripheries of the center circular holes of the silicon substrates.

FIG. 9 is a diagram for explaining the method of brush-polishing the outer peripheries of the silicon substrates.

FIG. 10 is a longitudinal sectional view of a conventional silicon substrate for a magnetic recording medium.

### BEST MODE FOR CARRYING OUT THE INVENTION

Hereinbelow, the present invention will be explained in detail.

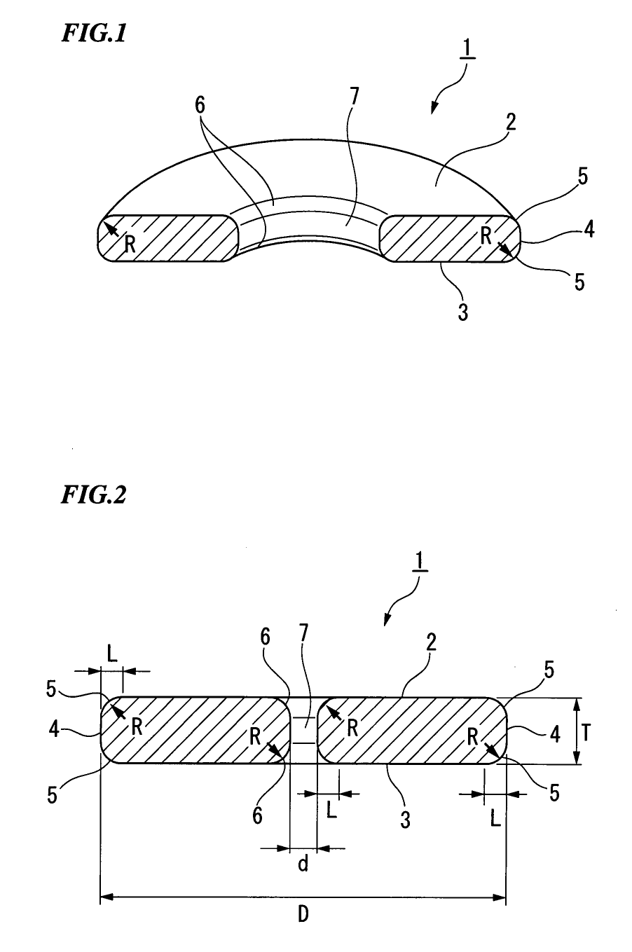

FIG. 1 is a perspective view of a silicon substrate for a magnetic recording medium according to the present invention, which is cut and viewed from the cut face. FIG. 2 is a diagram for explaining the dimension of each portion of the silicon substrate in FIG. 1 according to the present invention.

As shown in FIG. 1, the silicon substrate 1 for a magnetic recording medium according to the present invention forms a doughnut-shaped circular disk. The main surfaces 2 and 3 for implementing magnetic recording are formed on the front and back faces of the circular disk. The outer peripheral end face 4 is positioned at the outermost periphery of the circular disk, and the inner peripheral end face 7 is positioned at the inside of the center circular hole of the disk. Between the outer peripheral end face 4 and the main surfaces 2 and 3, outer peripheral curved surfaces 5 are formed, and inner peripheral curved surfaces 6 are formed between the inner peripheral end face 7 and the main surfaces 2 and 3.

The main surfaces 2 and 3, the outer peripheral end face 4, and the inner peripheral end face 7, are subjected to polishing so as to produce mirror-finished surfaces.

In the silicon substrate 1 for a magnetic recording medium according to the present invention, the radius R (of curvature) of the outer peripheral curved surfaces 5 between the outer peripheral end face 4 and the main surfaces 2 and 3, and the radius R of the inner peripheral curved surfaces 6 between the inner peripheral end face 7 and the main surfaces 2 and 3 are each from 0.01 mm to 0.05 mm.

According to such curved surfaces, even in a silicon substrate made of a fragile material, the corner portion does not break, and dust particles are not produced due to cracks or rubbing against a processing cassette and are not included in the substrate. Therefore, a smaller number of substandard magnetic recording media and a smaller number of write/read errors are produced.

When the radius R of the curved surface is less than 0.01 mm, the corner portion is too sharp and tends to break, and thus the curved surfaces do not produce sufficient effects. When the radius R of the curved surface exceeds 0.05 mm, a sufficient recording area cannot be secured on the main surfaces.

FIG. 2 shows dimensions of each portion of the silicon substrate 1 for a magnetic recording medium according to the present invention. In the Figure, reference symbol D indicates the outer diameter of the substrate, reference symbol d indicates the inner diameter of the center circular hole of the substrate, reference symbol T indicates the thickness of the substrate, and reference symbol L indicates a portion of the curved surface, which has the radius R.

Table 1 shows an example of the dimensions of each portion of the silicon substrate for a magnetic recording medium, according to the present invention.

The present invention can be widely applied to substrates having a size from 0.85 inch to 3.5 inch; however, the present invention produces remarkable effects when applied to ultra-small-sized substrates having a diameter of 0.85 inches or 1 inch as shown in Table 1. In each substrate size, an appropriate radius R of the curved surface is from 0.01 mm to 0.05 mm.

TABLE 1
unit: mm

| | outer diameter | diameter of | | width of | radius of |
|---|---|---|---|---|---|
| substrate | of substrate | inner hole of | thickness of | curved surface | curved |
| name: inch | (D) | substrate (d) | substrate (T) | portion (L) | surface (R) |
| 0.85 | 21.6 | 6.01 | 0.381 | 0.01 to 0.05 | 0.01 to 0.05 |
| 1.0 | 25.4 | 7.01 | 0.381 | | |

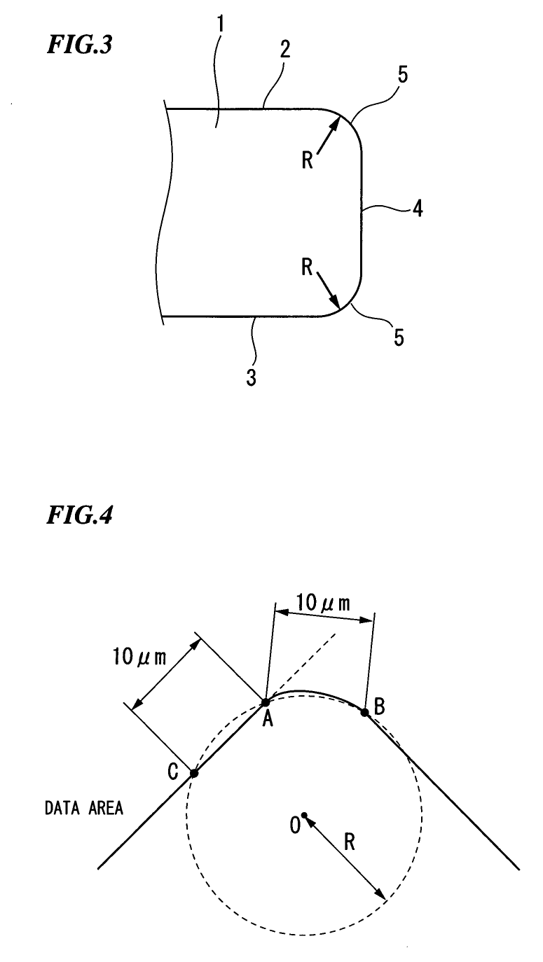

Next, an enlarged view of an outer peripheral portion of the silicon substrate 1 for a magnetic recording medium according to the present invention is shown in FIG. 3. Between the outer peripheral end face 4 and the main surfaces 2 and 3 of the silicon substrate 1, the curved surfaces 5 having a radius R from 0.01 mm to 0.05 mm are formed. No conventional type chamfered portion as formed in conventional substrates is formed in the silicon substrate for a magnetic recording medium according to the present invention.

Below, the method of measuring the radius R of the curved surface will be described with reference to FIG. 4. As shown in FIG. 4, an extension line S1 from the main surface is defined, and a start point A is defined at the position where the curved surface S2 is separated from the extension line S1. Point C on the main surface is away from the start point A by 10 μm, and point B on the curved surface is away from the start point A by 10 μm. The radius of a circle on which points A, B, and C are present is defined as the radius R of the curved surface. When the radius R of the curved surface is set to be from 0.01 mm to 0.05 mm, it is possible to prevent the relevant corner portion of the silicon substrate from breaking. When R<0.01 mm, the corner is too sharp and is weak to impact, and chips tend to be produced when the substrate is handled or hits something. When R>0.05 mm, the data recording area on the main surface is reduced, which is not preferable.

Additionally, in the silicon substrate 1 for a magnetic recording medium according to the present invention, the main surfaces, and the outer and inner peripheral end faces are subjected to polishing so as to create mirror-finished surfaces.

Regarding the surface roughness of the main surfaces, the maximum height Rmax is 10 nm or less, and for the surface roughness of the outer and inner peripheral end faces, the maximum height Rmax is 1 μm or less.

In addition, the accuracy of the diameter of the center circular hole of the silicon substrate should be within ±20 μm.

The above-described silicon substrate having curved surfaces of radius R is obtained by grinding outer and inner peripheral end faces using a grindstone, and polishing the ground portions using a polishing brush.

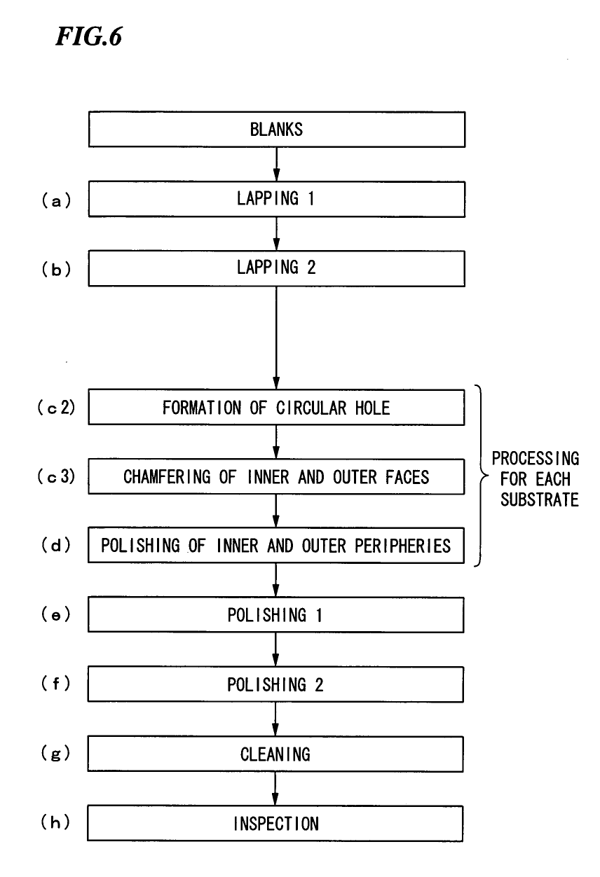

As shown in FIG. 6, conventional silicon substrates are manufactured in the following processes. First, in order to improve accuracies for shapes and dimensions, a disk-shaped silicon material is subjected to lapping which is performed in two steps by using a lapping apparatus, thereby achieving the conditions in which the surface accuracy is 1 μm or less, and Rmax for the surface roughness is 4 μm or less.

According to the first lapping step, Rmax for the surface roughness of the inner and outer peripheral end faces comes to approximately 6 μm, and according to the successive second lapping step, the surface accuracy comes to 1 μm or less, and Rmax for the surface roughness comes to 4 μm or less (see steps (a) and (b) in FIG. 6).

Next, after a circular hole is formed at a center of the substrate by using a cylindrical grindstone, a specific chamfering process is applied to the inner and outer peripheries (see steps (c2) and (c3) in FIG. 6).

Next, the inner and outer peripheral end faces and chamfered portions are subjected to polishing so as to produce mirror-finished surfaces (see step (d) in FIG. 6). The above processes are performed for every substrate (i.e., for each piece).

Finally, the main surface on which a magnetic recording medium is provided is subjected to polishing. This polishing process is performed in two steps. The first polishing step is performed for removing scars or distortions produced in the previous processes, and the second polishing step is performed for producing mirror-finished surfaces (see steps (e) and (f) in FIG. 6).

The silicon substrate after polishing is sufficiently cleaned, and then transferred to an inspection process (see steps (g) and (h) in FIG. 6).

According to the above processes, a conventional silicon substrate for a magnetic recording medium is obtained.

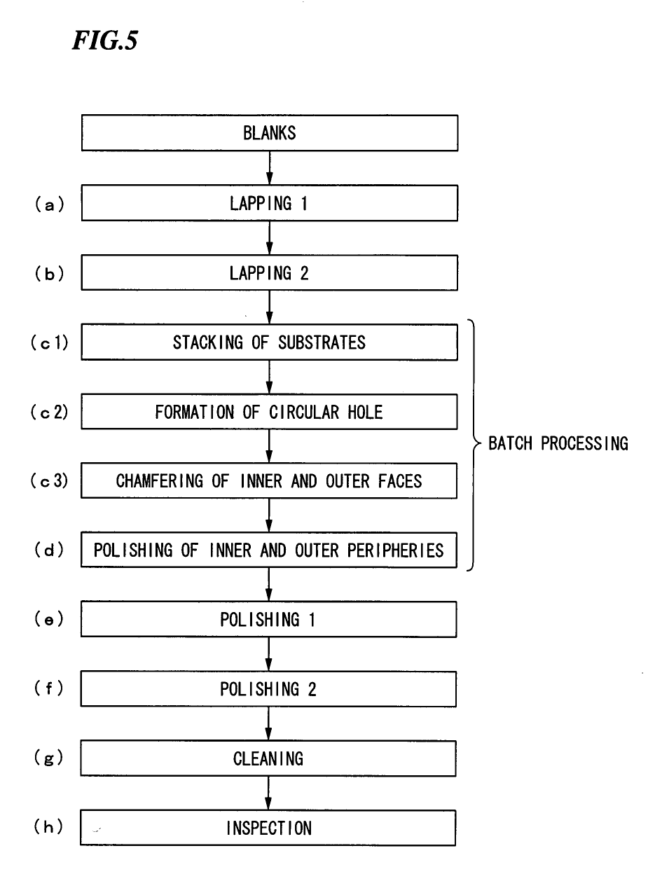

In the processes according to the present invention, as shown in FIG. 5, first, in order to improve accuracies for shapes and dimensions, a disk-shaped silicon material is subjected to lapping which is performed in two steps by using a lapping apparatus (see steps (a) and (b) in FIG. 5).

Next, a number of silicon substrates are bundled via spacers, so that a stack body of the silicon substrates is prepared (see step (c1) in FIG. 5). A circular hole is formed at a center portion of the stack body, and then a specific chamfering process is applied to inner and outer peripheries of the substrates (see steps (c2) and (c3) in FIG. 6).

Next, the inner and outer peripheral end faces and chamfered portions are subjected to brush polishing using a polishing brush (see step (d) in FIG. 5). In the method of manufacturing a silicon substrate for a magnetic recording medium according to the present invention, processing from formation of the circular hole to polishing of the inner and outer peripheries is batch processing applied to a stack body of the silicon substrates.

Finally, the main surface on which a magnetic recording medium is provided is subjected to polishing. This polishing process is performed in two steps. The first polishing step is performed for removing scars or distortions produced in the previous processes, and the second polishing step is performed for producing mirror-finished surfaces (see steps (e) and (f) in FIG. 5).

The silicon substrate, after polishing, is sufficiently cleaned, and then transferred to an inspection process (see steps (g) and (h) in FIG. 5).

In the method according to the present invention, a number of substrates are processed together, thereby remarkably improving production efficiency.

As described above, a silicon substrate for a magnetic recording medium according to the present invention is obtained, in which curved surfaces are formed at edge portions.

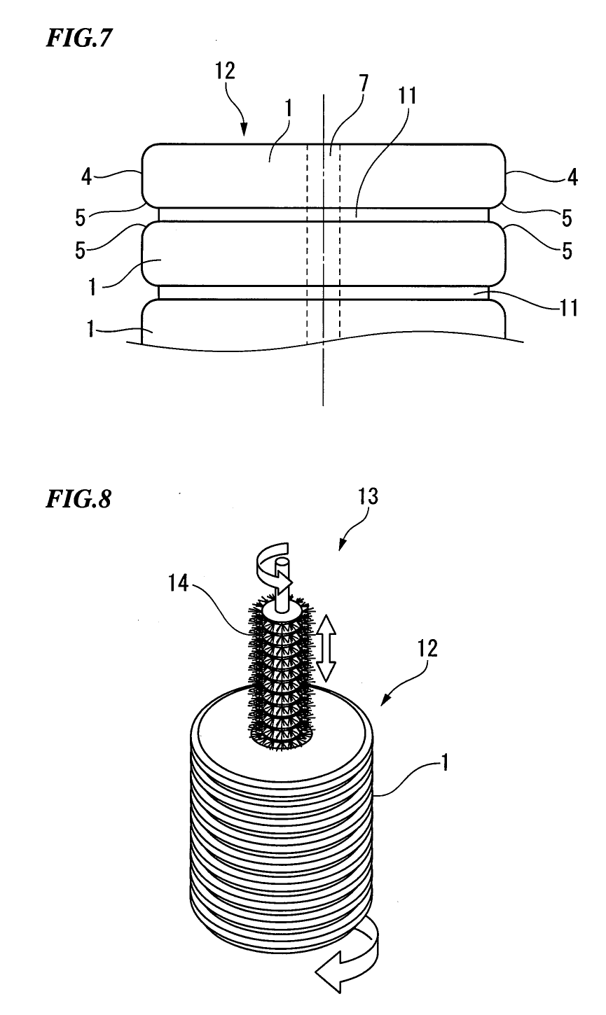

As explained above, processing from forming the circular hole to polishing the inner and outer peripheries is a batch processing applied to a stack body 12 of a number of silicon substrates, as shown in FIG. 7. The stack body 12 includes 100 to 200 silicon substrates 1, and spacers 11 are inserted between the silicon substrates 1.

Working efficiency is remarkably improved by using such a stack body of the silicon substrates.

The spacers 11 are provided for reliably preventing (i) insufficient polishing in the brush polishing process applied to the curved surfaces 6 of the inner peripheral end face 7 and the curved surfaces 5 of the outer peripheral end face 4, and (ii) breakage of the silicon substrate in the polishing process. Each spacer 11 has a circular disk shape having a center circular hole, similar to the shape of the silicon substrate. More specifically, the spacers are installed in a manner such that an end face (i.e., a side face) of each spacer 11 is positioned at approximately 0 to 2 mm (preferably, 0.5 to 2 mm) inward from the end face 4 of the silicon substrate 1. When the end face of the spacer is positioned further inward from the end of the chamfered portion of the substrate, brush hairs reach the main surface areas of the silicon substrate (though depending on the thickness of the spacer and the diameter of the brush hair), and a ridge portion between the main surface and the chamfered portion is rounded. In addition, the thickness of the spacer 11 is appropriately adjusted according to the diameter of the hair of the polishing brush. Preferably, the thickness is approximately 0.1 to 0.3 mm. In addition, a preferable material for the spacers 11 is polyurethane, acryl, epoxy, the same material as that of a polishing pad used in the polishing process, or the like, which is softer than the silicon substrate. That is, it is preferable to use spacers 11 made of a soft material adapted to prevent the silicon substrate from breaking due to pressure from the polishing brush or the polishing pad.

In the polishing process, first, a number of silicon substrates and a number of spacers are alternately inserted into a specific jig (not shown), and this body is bound tight and clamped using a binding cover, thereby forming a stack body of the silicon substrates. Next, a polishing brush is inserted into the center circular hole of the silicon substrate 1, and the amount of pressing by the polishing brush is adjusted so that the hairs of the brush contact the inner peripheral end face of each substrate.

Preferably, the polishing brush is formed by tying up polyamide resin fibers into a corkscrew form, in which the diameter and the length of the brush hairs are respectively 0.05 mm to 0.3 mm, and 1 to 10 mm.

In the next step, a case in which the substrates are contained is filled with an appropriate amount of a polishing liquid. As shown in FIG. 8, a relative vertical motion between the stack body 12 of the silicon substrates 1 and the polishing brush 13 is performed while respectively rotating the stack body 12 and the brush 13 in opposite rotational directions, thereby brush-polishing the inner peripheral faces of the substrates. Preferably, the rate of rotation of the stack body 12 of the silicon substrates is approximately 60 rpm, and the rate of rotation of the polishing brush 13 is approximately 1000 to 3000 rpm.

According to the brush polishing for the inner peripheral faces, the contact line between the main surface and the inner peripheral end face results in a curved surface having a radius of 0.01 to 0.05 mm.

After brush polishing of the inner peripheral end faces, the outer peripheral end faces of the substrates are polished using a brush.

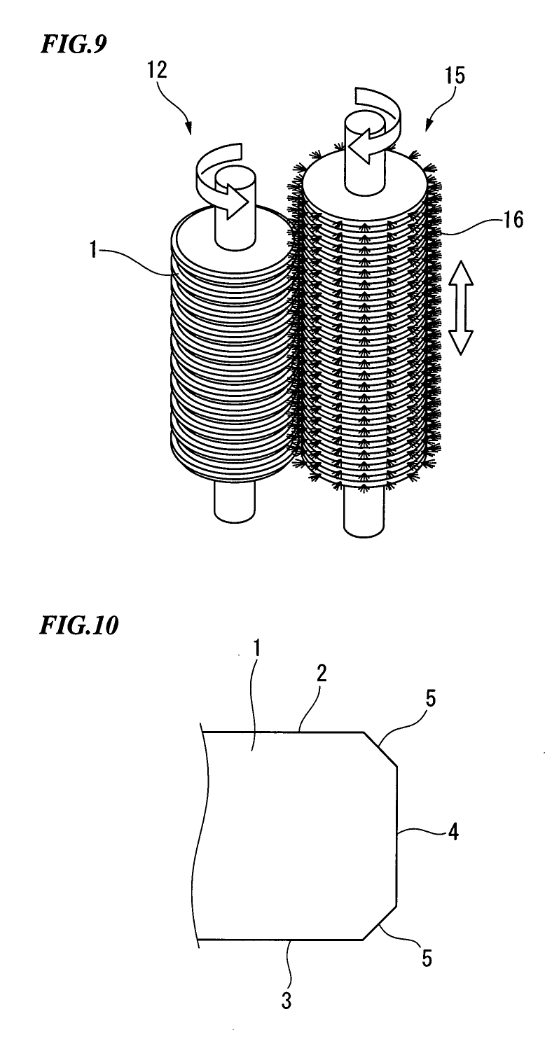

As shown in FIG. 9, a cylindrical brush 15 is pushed against the end faces of the silicon substrates 1 of the stack body 12. Preferably, the cylindrical brush 15 is formed by tying up polyamide resin fibers into a corkscrew form, in which the diameter and the length of the brush hairs 16 are respectively 0.05 mm to 0.3 mm, and 1 to 30 mm, and the diameter of the cylindrical brush 15 is 200 to 500 mm. This cylindrical brush 15 is pushed against the outer peripheral portion of the stack body 12 of the silicon substrates 1, and a relative vertical motion is performed between the stack body 12 of the silicon substrates and the cylindrical brush 15 which are simultaneously respectively rotated in opposite rotational directions at respective rates of rotation of 60 rpm and 700 to 1000 rpm while supplying a polishing liquid to a contact face between the outer periphery of the stack body 12 and the polishing brush 15. Thereby, the outer peripheral end faces of the silicon substrates 1 are brush-polished.

After the brush polishing, each silicon substrate is cleaned using water, and the main surface of the substrate is subjected to a first polishing step which is performed for removing scars or distortions produced in the previous processes.

In this first polishing step, a polishing apparatus which is usually used is used. In polishing using the polishing apparatus, a polishing liquid obtained by adding colloidal silica to water is used; the load is approximately 100 g/cm²; a target removal amount in polishing is 30 μm; the rate of rotation of the lower surface plate is 40 rpm; the rate of rotation of the upper surface plate is 35 rpm; the rate of rotation of the sun gear is approximately 14 rpm; and the rate of rotation of the internal gear is approximately 29 rpm. After the first polishing step, the silicon substrate is cleaned using water, and is transferred to a second polishing step.

That is, the second polishing step as a finishing process is applied to the main surfaces of each silicon substrate which was subjected to the first polishing step. As conditions for the second polishing step as finish polishing, a polishing liquid obtained by adding colloidal silica to water is used; the load is approximately 100 g/cm²; a target removal amount in polishing is 5 μm; the rate of rotation of the lower surface plate is 40 rpm; the rate of rotation of the upper surface plate is 35 rpm; the rate of rotation of the sun gear is approximately 14 rpm; and the rate of rotation of the internal gear is approximately 29 rpm.

After the second polishing step, the silicon substrate is immersed in neutral detergent, pure water, pure water and IPA (isopropyl alcohol), and IPA (for vapor drying) in turn, which are respectively contained in cleaning tanks, thereby performing ultrasonic cleaning of the silicon substrate.

According to the above-described processes, a silicon substrate for a magnetic recording medium is obtained, in which the end faces and the chamfered portions are mirror surfaces, and curved surfaces having a radius from 0.01 mm to 0.05 mm are provided between the main surfaces and the end faces of the substrate. This silicon substrate has no conventional type chamfered portion; thus, a wider data recording area is obtained in comparison with conventional substrates.

This silicon substrate for a magnetic recording medium is made of fragile silicon; however, chips in end faces or cracks in the substrate are not easily produced, thereby preventing the occurrence of dust particles produced from end faces of the substrate, or due to rubbing with a processing cassette.

In addition, the chamfering process for every substrate is omitted and brush polishing is instead performed in a batch processing. Therefore, the manufacturing processes are considerably simplified and production efficiency is improved, thereby contributing to cost reduction.

On either face of the silicon substrate obtained as described above, layers are deposited by a known method, for example, a CrMo base layer, a CoCrPtTa magnetic layer, and a carbon hydride protection layer are deposited in turn by using an in-line sputtering apparatus or the like, and then a perfluoropolyether liquid lubricating layer is further deposited using a dipping method, thereby obtaining a magnetic recording medium.

The magnetic recording medium according to the present invention, obtained by the above processes, has curved surfaces having a radius from 0.01 mm to 0.05 mm between the main surfaces and the end faces; thus, chips in the end faces or cracks of the substrate are not easily produced, thereby preventing the occurrence of dust particles produced from an end face of the substrate, or due to rubbing with a processing cassette. Accordingly, it is effective for preventing write/read errors or a crash of the magnetic head in the write/read process.

### CONCRETE EXAMPLES

Twenty silicon substrates, each having a diameter of 21.6 mm (called “0.85 inch”), and twenty silicon substrates, each having a diameter of 25.4 mm (called “1 inch”), were prepared. These substrates were subjected to the series of the above-explained processes, namely the first lapping step, the second lapping step, the step of forming a circular hole, the step of chamfering the inner and outer peripheral end faces, the step of brush-polishing the inner and outer peripheral end faces, the first polishing step for the main surfaces, and the second polishing step for the main surfaces, in turn. Accordingly, silicon substrates having curved surfaces of a radius from 0.01 mm to 0.05 mm at the corners on the outer peripheral side and the inner peripheral side of each main surface were obtained (see Table 2).

In the steps of grinding (i.e., chamfering) and brush-polishing the inner and outer peripheral end faces, a stack body of the silicon substrates was used, in which spacers made of epoxy resin were inserted between the silicon substrates, each spacer having a diameter of 20.5 mm (for 0.85 inch substrates) or 24.5 mm (for 1 inch substrates), and a thickness of 0.2 mm.

Additionally, in the step of brush-polishing the inner peripheral end faces, a polishing brush formed by tying up polyamide resin fibers into a corkscrew form was used, in which the diameter and the length of the brush hairs were respectively 0.1 mm and 1 mm, and a polishing liquid obtained by suspending alumina abrasive grains having a grain size of #400 in water was used. This polishing brush was inserted into the center circular hole of the silicon substrates, and polishing was performed while the stack body of the silicon substrates and the polishing brush were respectively rotated in opposite directions at rotation rates of 60 rpm and 1500 rpm.

After the polishing of the inner peripheral end faces, the outer peripheral end faces of the silicon substrates were brush-polished. In this polishing, a cylindrical brush formed by tying up polyamide resin fibers into a corkscrew form was used, in which the diameter and the length of the brush hairs were respectively 0.1 mm and 20 mm, and the diameter of the cylindrical brush was 300 mm. In the polishing process, the stack body of the silicon substrates and the cylindrical brush were respectively rotated in opposite directions at rotation rates of 60 rpm and 900 rpm while the brush was pressed against the end faces of the substrates and a polishing liquid was supplied to the contact portion between the polishing brush and the outer periphery of the stack body of the silicon substrates.

The 20 silicon substrates for each of “0.85 inch” and “1 inch” were obtained as explained above, and the recording area on the main surface of the substrates was computed (see Table 2).

TABLE 2
unit: mm

| | outer diameter | diameter of inner | radius of | recording | rate of area |
|---|---|---|---|---|---|
| substrate | of substrate | hole of substrate | curved surface | surface area | expansion |
| name: inch | (D: mm) | (d: mm) | (R: mm) | (S: mm²) | (%) |
| 0.85 | 21.6 | 6.01 | 0.01 | 337.02 | 1.56 |
| | | | 0.05 | 333.56 | 0.52 |
| 1.0 | 25.4 | 7.01 | 0.01 | 446.85 | 1.32 |
| | | | 0.05 | 464.82 | 0.88 |

In addition, finishing accuracy in the vicinity of the outer peripheral end faces of the silicon substrates was observed.

Next, for the above 20 silicon substrates, vibration was applied, which was anticipated when transferring each substrate using a transfer cassette, and the occurrence of scars and dust particles produced at the end faces of the substrates was investigated.

Regarding the generation of scars at the end faces of the substrates, the end face of each substrate was observed using an optical microscope. The test for investigating for dust particles was performed using a transfer cassette through the following steps.

(1) Each silicon substrate was contained in the cassette, and a top cover was attached to the cassette so as to pack the substrate in the cassette.

(2) In consideration of a transfer process, the silicon substrate was respectively moved toward the bottom and the ceiling of the cassette, each ten times.

(3) In consideration of a process of installing and taking out the silicon substrate from the cassette, the substrate was alternately taken out from and installed to the slot of the cassette ten times.

After performing the above steps (1) to (3), the number of polycarbonate particles generated at the outer periphery of the substrate was measured using an optical microscope, where the cassette was made of polycarbonate. In the measurement, 20 substrates for each of 0.85 inch and 1 inch were observed, and the measured number of particles was divided by the number of substrates (i.e., 20), and comparison was performed for the obtained quotients. The results of the above observation and the test are shown in Table 3.

TABLE 3

| | examples of present invention | | comparative |
|---|---|---|---|
| | 0.85 inch | 1 inch | example |
| generation of scars | no scars | no scars | a few scars |
| (longitudinal) | | | |
| generation of scars | no scars | no scars | a few scars |
| (transverse) | | | |
| rate (%) of generation | 0 | 5 | 20 |
| of particles at | | | |
| periphery of substrate | | | |

### COMPARATIVE EXAMPLES

For comparison, similar evaluation was performed for a substrate having conventional chamfered portions, and curved surfaces of a radius of 0.005 mm between the main surfaces and the chamfered portions of the substrate. These results are also shown in Table 3.

According to the above evaluations, when curved surfaces having a diameter from 0.01 to 0.05 mm are provided between the main surfaces and the chamfered portions in a fragile silicon substrate, chips or cracks are not easily generated at end faces of the substrate. Therefore, it is possible to prevent dust particles from generating at the end faces, and also generation of dust particles due to rubbing against a processing cassette.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### INDUSTRIAL APPLICABILITY

A silicon substrate, which is fragile but has a form by which cracks in an end face or chips on the substrate are not easily produced, can be obtained, thereby preventing the occurrence of dust particles produced from the end face of the substrate or due to rubbing against a processing cassette. Therefore, a smaller number of substandard products and a smaller number of write/read errors are produced. In addition, it is possible to provide a low-priced ultra-small-sized magnetic recording medium having a large storage capacity.

1. A silicon substrate for a magnetic recording medium, wherein a curved surface having a radius from 0.01 mm to 0.05 mm is provided at an edge portion between a main surface and an end face of the substrate.

2. The silicon substrate as claimed in claim 1, wherein the curved surface between the main surface and the end face is provided at an outer periphery of the substrate.

3. The silicon substrate as claimed in claim 1, wherein the curved surface between the main surface and the end face is provided at an inner periphery of the substrate.

4. The silicon substrate as claimed in claim 1, wherein the maximum height for surface roughness for the end face is 1 μm or less.

5. The silicon substrate as claimed in claim 1, wherein the maximum height for surface roughness for the main surface is 10 nm or less.

6. A manufacturing method for silicon substrate for a magnetic recording medium, comprising the steps of:
forming a circular hole at a center of the silicon substrate;
immersing the silicon substrate in a polishing liquid in which grains are suspended; and
respectively polishing an outer peripheral end face and an inner peripheral end face of the silicon substrate, wherein in polishing of each end face, a polishing brush contacts the end face while performing a relative rotation between the end face and the polishing brush.

7. The manufacturing method as claimed in claim 6, wherein the step of respectively polishing the outer peripheral end face and the inner peripheral end face is performed after inner and outer peripheries of the silicon substrate are subjected to chamfering.

8. The manufacturing method as claimed in claim 6, wherein the step of respectively polishing the outer peripheral end face and the inner peripheral end face is performed in a batch processing using a stack body of a number of silicon substrates stacked via spacers therebetween.

9. The manufacturing method as claimed in claim 6, wherein the polishing brush is made of polyamide resin.

10. A magnetic recording medium made using a silicon substrate as claimed in claim 1, wherein at least a magnetic layer is formed on the main surface of the silicon substrate.
